(19) United States
(12) Patent Application Publication
(10) Pub. No.: US 2003/0154168 A1
(43) Pub. Date: Aug. 14, 2003

(54) METHOD FOR USING SOFTWARE PRODUCTS THAT ARE OFFERED VIA A NETWORK

(75) Inventor: Markus Lautenbacher, Oberammergau (DE)

Correspondence Address: NEIFELD IP LAW, PC, 2001 JEFFERSON DAVIS HIGHWAY, ARLINGTON, VA, 22202, US

(73) Assignee: Richard a Neifeld

(21) Appl. No.: 09/513,462

(22) Filed: Feb. 25, 2000

(30) Foreign Application Priority Data
Jan. 18, 2000 (EP) 00100922.4

(51) Int. Cl. G06F 17/60

(52) U.S. Cl. 705/51

(57) ABSTRACT

The invention provides a way for a network provider to assume the processing for the usage of software products that are offered via a network. The network provider can offer this processing as a service for the provider of software products, who wishes to “outsource” these tasks.

### BACKGROUND OF THE INVENTION

1. Field of the Invention

The present invention relates to having a network provider assume the processing for the usage of software products that are offered via a network.

2. Description of the Related Art

In modern networks (such as the Internet), in which software products are offered for sale or as a service, three different participants generally play a role (see FIG. 1) 1) the network operator, 2) the provider of software products, and 3) the end user.

Network Operator Role

The network operator (or “network provider”) operates and administers a network that primarily provides a “bit-transport” functionality. The network operator provides network connectivity for the web servers of the provider of software and contents or he may assume this function vicariously by providing a web server for the provider (“web hosting”). The network operator also provides network connectivity for the end user, normally as dial-in via a modem or ISDN, and thus normally has an established and long term business relationship with the end user: He sends the end user invoices about received network connectivity performances on a regular basis and knows his financial actions.

Provider of Software Products Role

The main competence of a provider of software products lies in the preparation of software products, including action-oriented software products (“software”, e.g., 1: applications, such as services, tools, etc. or 2: games, etc.), and content-oriented software products (“contents”, e.g., studies, branch-oriented news, etc. ). The provider sells this software and/or contents by providing it on a web server for downloading by the end user. The fees for this software and content for the end user can be small, depending upon the fee model.

The provider, however, does not have an established and long term business relationship with the end user, due to the statistical nature of web surfing. Furthermore, the provider's main competence does not consist in charging, particularly for small fee amounts and the economic expenditures required to administer such charging.

End User Role

An end user who is using the web normally jumps (for example, via a search engine) in a statistical manner from web site to web site. He does not have (or does not want to have) an established and long term business relationship with the numerous visited providers of software and contents. Rather, he wishes to receive the offered performances “on-demand” and wants to receive the appertaining charges optimally on one invoice from a source that he is familiar with. The network operator is the only such familiar source because the network operator already provides the end user with the network connectivity and charges him for it.

A technical solution that allows convenient and economical charging for the usage of software and contents in networks is desired in such a scenario, which can include different charging models (including very small amounts). A user-specific degree of access control to software and contents is desirable as well (e.g., controlling access by children). The installation and configuration expenditures necessary for the method on the side of the end user would have to be negligible and be economically and technically feasible in order to assure broad acceptance by end users.

In previous solutions, unmodified software or contents were provided on web servers. The end user downloaded it from these servers onto his personal terminal device, installed it, and used the corresponding software or contents.

As to access control, the following models are conceivable and desirable, but may not always be possible (embodying criteria such as type of content and payment of the utilized performances, etc ): 1) the time-limited free trial, and 2) content-based access control.

Time-Limited-Free-Trial Model

In this model, the end user can gratuitously use the software or contents for a limited period of time after installation on his terminal device. At present, the validity of such use is determined locally on the user's terminal device by, e.g., inquiry of associated data or of the Windows™ Registry; such a scheme can easily be cracked

Content-Based Access Control Model

The current technical solutions do not allow access control for the usage of the downloaded software or contents with respect to a fixed, end user-specific profile as long as the control instance lies solely on the device of the end user.

As to charging, the following models are conceivable and desirable, but may not always be possible: 1) pay per use, and 2) one-time full purchase.

Pay Per Use Model

Charging, generally of very small amounts, according to the actual usage frequency of the software or contents is currently not possible.

One-Time Full Purchase Model

The single registration and payment of a full version for the unrestricted usage of the software or contents may take place off-line via telephone/fax or in a credit card transaction. This is the only charging method that is currently in place.

When at least local protection mechanisms with respect to the access control in the software and contents are not present, there is considerable illegal, unpaid usage by end users that are not registered, and the economical damage is correspondingly high for the provider without access control.

### SUMMARY OF THE INVENTION

According to the present invention, a service provider (e.g., the network operator) assumes the usage processing, (e.g., “charging and/or access control”) for the usage of software and contents. The network operator offers this as a service for the provider of software and contents, when the provider wishes to “outsource” these tasks in order to be able to concentrate on the preparation of software and contents. The provider of software and contents can also avoid the charging of very small amounts, which may not be economical for him, via “outsourcing”.

Providing usage processing, such as charging and/or access control, is particularly advantageous for the network operator since the end user is already connected to the network of the network operator for purposes of the network connectivity, and therefore is in a long term business relationship with the network operator.

The fact that the end user's device on which the software and contents are to be used is connected to the network enables improved access control to software and contents by way of the network operator as a third source which is not only independent of the end user but also of the provider. The existence of a business relationship enables the collection of charges for performances that are received by the end user at third parties in the network vicariously by the network operator for a third party in the network.

The network-supported access control and charging is technically realized by inserting a corresponding software module into the original source code of the software and contents by the provider. The network operator gives the provider of software and contents with this software module in the form of a software development kit when the provider subscribes to the service “network-supported access control and charging of software and contents” at the network operator location. The network operator assumes the corresponding certificate-supported validation and charging of the thus modified software and contents as the central and certificated instance in the network.

The advantages for the network operator are that the inventive solution makes it possible for the network operator to provide more than simply a pure bit transport in his business and allows an expansion in the direction of multiple and/or increased value services.

As to the end users, the network operator can offer specific accounts with cost- and access control regarding specific software and contents for under age persons and children.

As to the provider, the network operator can assume the accounting and managing the charging of performances that the end user received from the provider. Small amounts can also be economically charged, since the network operator, in the framework of his other charging operation for the network sources used by the end user, for example, already has the resources and experience required to perform this function.

The advantages for the provider of software and contents are that the provider can “outsource” the charging of software and contents vis-a-vis the end user and can concentrate on his software or content development. In contrast to the current state, new, network-supported charging models are available to the provider in public networks due to pay-per-use and one-time-full-buy.

At the same time, the network-based, certificate-supported central access control for the usage of software and contents is more secure than the current practice of control via local resources on the device of the end user.

The insertion of a corresponding software module into the original source code of the software and contents by the provider does not represent a problem from a technical standpoint and does not represent a problem with respect to expenditures required.

Finally, the advantages for the end user are that the network operator provides the end user with an account for the usage of software and contents (e.g., age-related and content-related accounts, cost control via prepaid accounts, etc.), which is specifically designed for his requirement profile.

For all such received performances, he receives one single invoice from the network operator, who represents a service provider he knows and trusts. This allows the end user to use offers of different providers at the same time, without having to enter into his own business relationship with others, respectively (possibly for small amounts).

In the pay-per-use charging model, the end user at all times can legally use, in an economical manner, the up-to-date version of software and contents, where such software or contents might be rarely needed. For this purpose, he does not have to initially pay the full purchase amount, (which could be high), but rather pays only a small amount which becomes due with each use. In this charging model, the end user only pays for the actually used software and contents usage.

### BRIEF DESCRIPTION OF THE DRAWINGS

FIG. 1 is a block diagram showing the corresponding steps for the case of the service “charging and access control”;

FIG. 2 is a block diagram showing the transaction flow between the end user and the network operator;

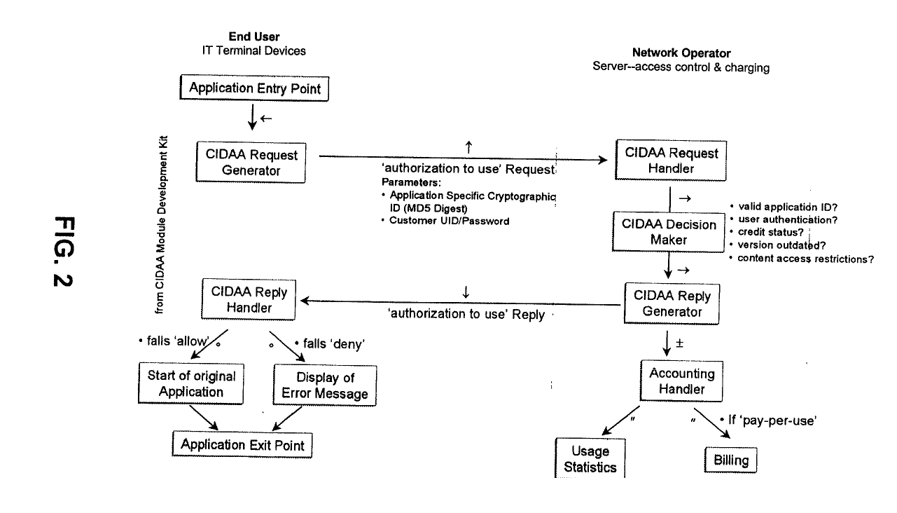

FIG. 3 is a block diagram showing an overview of an exemplary embodiment of the present inventive system;

FIG. 4 is a block diagram showing a partial overview of this system with the essential elements for the access of the end user to the end user service web site of the network operator;

FIG. 5 is a block diagram showing a partial overview of this system with the essential elements for the access of the provider of software and contents to the provider-service-web site of the network operator;

FIG. 6 is a block diagram showing a partial overview of this system with the essential elements for the supply of a CIDAA-capable software application and contents by the provider; it also shows the subsequent download by the end user onto his terminal device; and

FIG. 7 is a block diagram showing a partial overview of this system with the essential elements for the usage of a CIDAA-capable software application and contents by the end user.

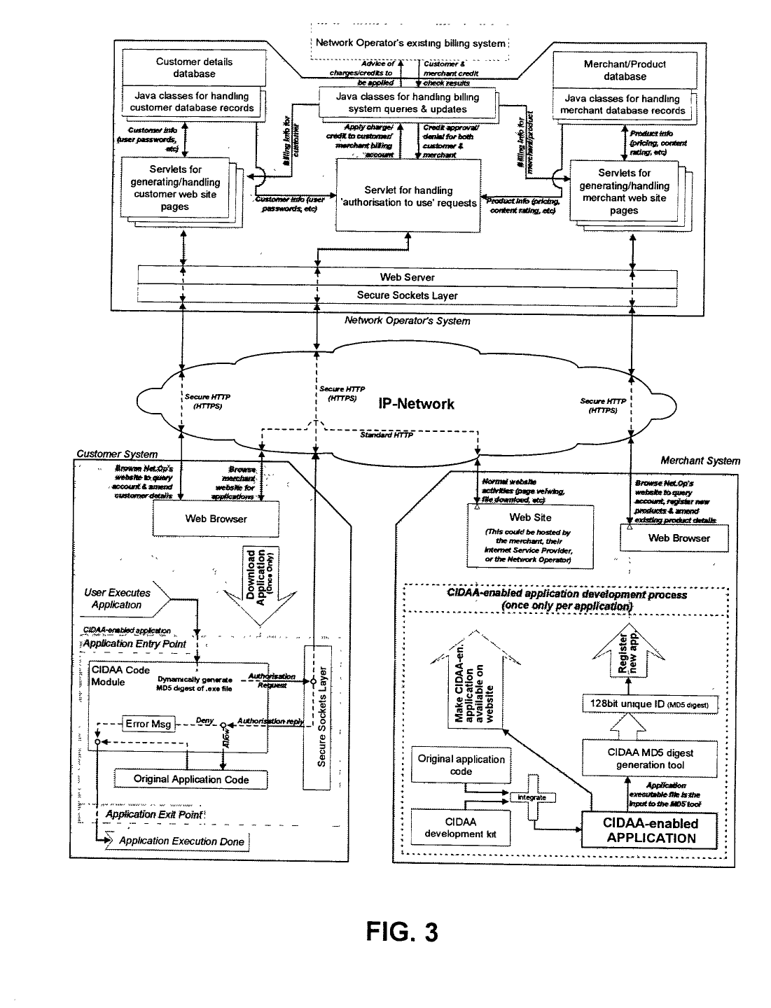

In FIGS. 3-7, the term “customer” is interchangeable with the term “end user”, and the term “merchant” is interchangeable with the term “provider”.

### DESCRIPTION OF THE PREFERRED EMBODIMENTS

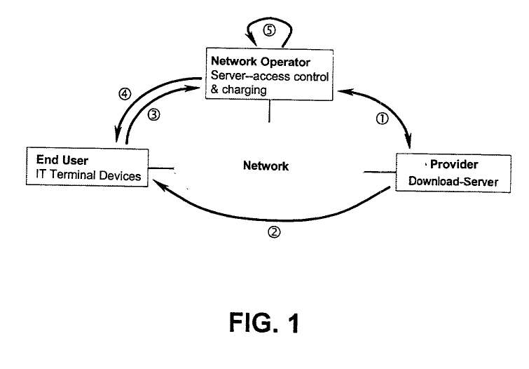

The corresponding steps for the case of the service “charging and access control” are schematically shown in FIG. 1:

Step 1: The manufacturer of software and contents subscribes to the service “network-supported access control and charging of software and contents” at the network operator. In order to subscribe, he receives a software development kit from the network operator which allows him to build in a software component into the source code of his software or the contents, where the software component realizes a network-supported access control and charging. This software will be referred to below as “service module” or “access control- and charging module”.

Step 2: The manufacturer or a corresponding service provider provides the software and contents correspondingly protected by way of the above cited software development kit on an arbitrary web server in the network so that it can be downloaded. From this web server, the end user downloads the software and contents onto his terminal device and installs it there.

Step 3: When someone calls the software and contents, the service module, which is introduced via the software development kit for purposes of controlling the access and charging, contacts the corresponding server of the network operator via the network; this takes place immediately after the start of the software and contents. This contact between the service module and server via the network requires an always-on network connection or at least requires a sufficiently fast dial-up-on-demand method at the end user side. For purposes of controlling the access and charging, data, such as cryptographic identification character (a one-to-one corresponding identification number or valid charging model) of the software and contents, user data (a user identification character, password, or account number), are thereby transferred to the network operator.

Step 4: The network operator checks the data received by the end user regarding correctness, topicality and compatibility of the profile that is preset by the customer. When the end user inquires about the usage of specific software and contents, the following exemplary information can be co-considered on the server of the network operator: the cryptographic identification character and version number of the software and contents, the type of the software and contents to be used with respect to a preset user profile (such as age restriction, restriction with respect to specific contents, etc.) of the end user, and the creditworthiness and account balance of the end user. Such a finely-adjusted checking could not be performed in a secure manner on the device of the end user.

At the end of the check, the server of the network operator, via the network connection, reports back to the corresponding access control- and charging model on the side of the end user whether the end user is allowed to use the software and contents: If so, the software and contents continues with its normal functioning; if not, the access control- and charging model terminates the software and contents with an error message and thus prevents their unauthorized usage by the end user.

Step 5: When the end user inquiry has been positively answered by the server, the corresponding charging operations are subsequently carried out on the accounts of the participants: The account of the end user is debited with an amount X for the usage, where charges for software and contents apply (X=0 for offers that are free of charge). The provider receives this amount X on his account, minus a service charge Y. The service charge Y arises for the provider of software and contents, since he used the end user control- and charging service of the network operator for the transaction described in steps 3 and 4 above.

When the server of the network operator rejects the end user inquiry to use the software and contents, this is also appropriately registered in the operation protocols of the server.

FIG. 3 shows the above cited steps 3 and 4 in greater detail between software and contents with an access control- and charging module at the side of the end user and between the control- and charging instance at the side of the network operator:

1. The access control- and charging module (Cryptographic ID based authorization and accounting (CIDAA) module) is inserted into the normal program run immediately after the software and contents have been started. This takes place by way of inserting the corresponding software development kit into the original source code of the software and contents.

2. The CIDAA request generator of the CIDAA module places a request via the network of the network operator for purposes of controlling the access and charging with respect to the CIDAA request handler on the corresponding server of the network operator. A cryptographic identification character that is specific for the respective software and content is thereby transferred in the direction of the network operator in the form of a what is referred to as MD5 digest, as well as an identification character and password of the end user. Prior to this, the CIDAA module requests the end user to input the identification character and password. MD5 is a special type of the general class of “hash functions”, which are used in order to biuniquely reduce digital signatures of digital data to “message digests” for purposes of improved handling.

3. The “CIDAA decision maker” takes different criteria into consideration in order to decide whether to allow the inquiry of the end user to use the software and contents.

Possible criteria are:

a) the correct cryptographic identification character of the software and contents, registered at the network operator;

b) the correct authorization of the end user via user identification character and password;

c) the version number of the software and contents (to determine if the version is potentially out of date);

d) the type of the software and contents to be used with respect to a preset profile of the end user (e.g., restriction with respect to specific contents for accounts of under age persons, etc.); and

e) the creditworthiness and account balance of the end user.

4. The “CIDAA reply generator” on the side of the network operator sends the corresponding response regarding the inquiry from step 2 to the CIDAA handler in the CIDAA module at the side of the end user.

5. If the inquiry has been positively answered, the CIDAA module, proceeding from the reply handler, gives up the control and the original program run of the software and contents is continued. If the inquiry has been negatively answered, the CIDAA module displays a corresponding error message.

6. Apart from the reply to the CIDAA reply handler, the CIDAA reply generator also provides information for the “accounting handler” on the server of the network operator.

7. The accounting handler carries out the corresponding charging operations on the accounts of the end user and of the provider of software and contents. In addition, the accounting handler also keeps statistics about the CIDAA inquiries that have taken place and about the result of their processing.

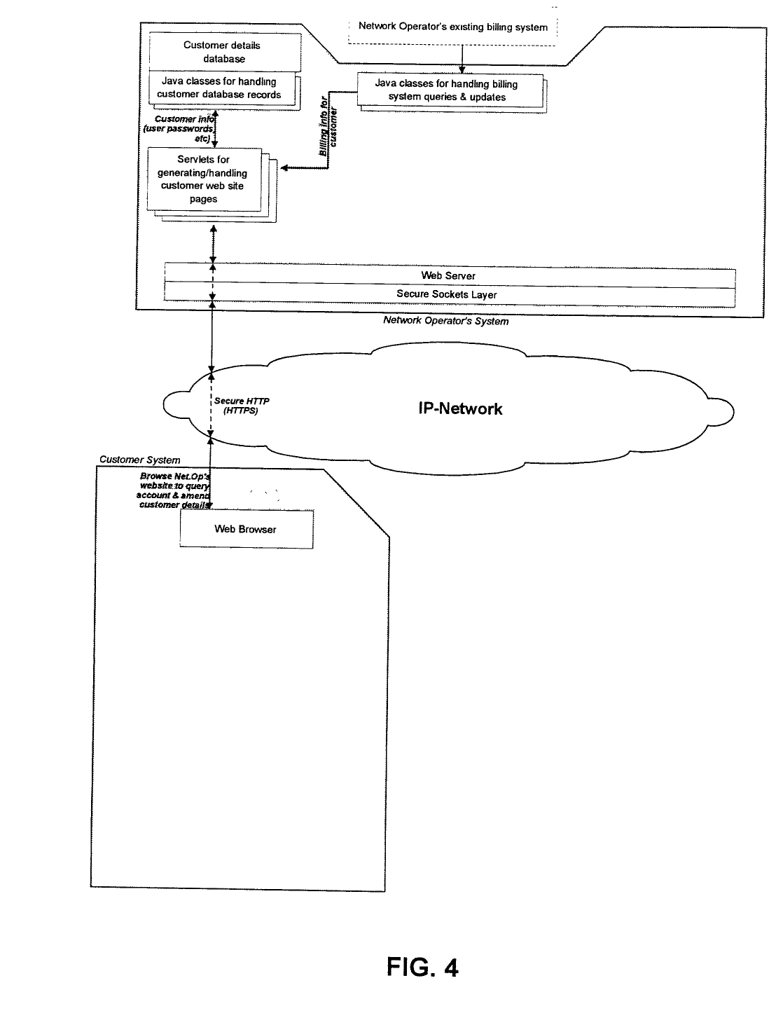

FIG. 4 shows a partial overview of the system with the essential elements for the access of the end user to the end user service web site of the network operator by which the end user can look into his current account data (e.g., current charge balance) by way of a standard web browser and can undertake changes at his user profile that is stored in the “customer details database” at the network operator's system (e.g., changing the accounting address).

The communication between the web browser of the end user and the web server of the network operator takes place using HTTP via “Secure Socket Layer” (SSL), namely via “Secure HTTP” (HTTPS). The end user needs his user identification character and password for the access to the above cited data.

The corresponding service logic at the side of the web server is realized in “java servlet” technology. Different service-specific java servlets implement the respective service logic. At the same time, they form the interface to the web browser as the service interface of the end user. For this purpose, the servlets generate corresponding web pages and transfer these to the web browser of the end user via HTTPS or, respectively, react to user actions that are initiated by web pages that are generated in this way.

Accesses to data banks and charging systems, where these accesses are necessary for the service logic, are not implemented in the different servlets themselves and are therefore multiply implemented. Corresponding java classes realize the inquiries and changes in the “customer details database” and in the external (normally already existing) charging system of the network operator, once.

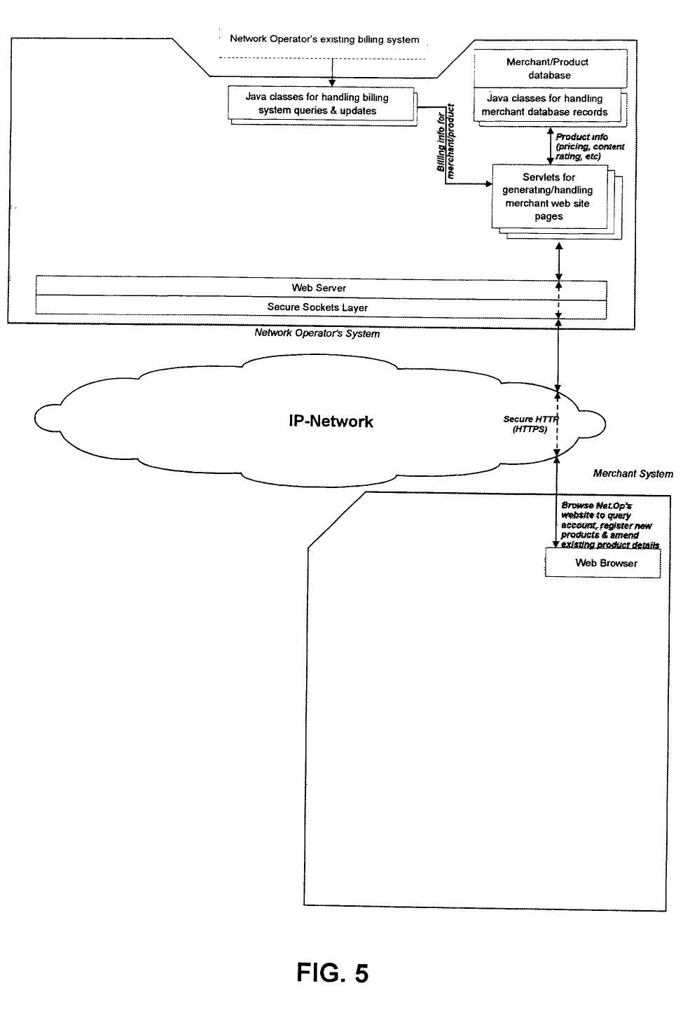

FIG. 5 shows a partial overview of the system with the essential elements for the access of the provider of software and contents to the provider-service-web site of the network operator, in which the technical realization corresponds to the one of the access of the end user to the end user-service-web site in FIG. 4.

It is possible for the provider to look into his current account in the “merchant database” (e.g., the current deposit balance) and to partly undertake changes there. Furthermore, he can undertake changes in the product database for the software and contents that belong to him and, according to the CIDAA method, that are controlled and charged for him by the network operator, such as changes with respect to the cryptographic identification character and price, changes regarding the content rating (e.g., age restriction), etc.

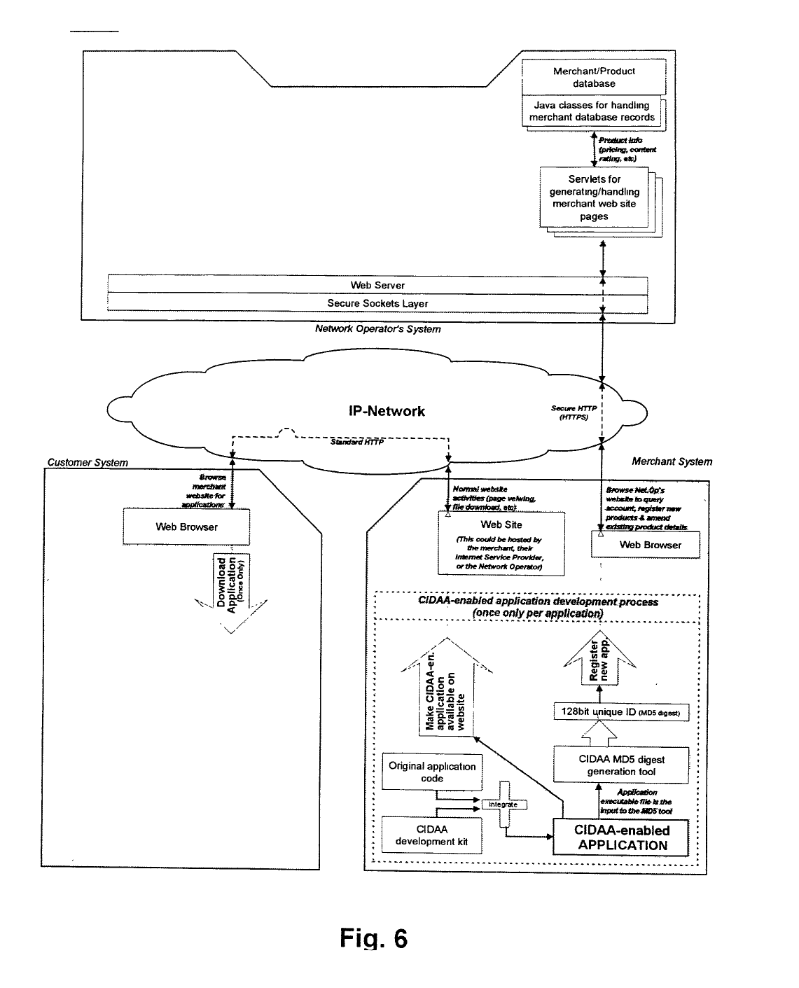

FIG. 6 shows a partial overview of the system with the essential elements for the supply of a CIDAA-capable software application and contents by the provider and shows the subsequent download by the end user onto his terminal device. For every CIDAA-capable software and contents and software and contents that are administered by the network operator, the following steps are performed by the provider:

a) integrating the original application source code or of the contents together with the CIDAA development kit to an executable file of a CIDAA-capable software application or to a self-extracting executable file for contents. The network operator provides the provider of software and contents with the CIDAA development kit as soon as the provider has subscribed to the service “network-supported access control and charging of software and contents” at the network operator site.

b) generating a biunique cryptographic, 128 bit long, digital identification character (“128 bit unique ID”) by way of a generation tool, which is a part of the CIDAA development kit. The generated identification character is an MD5 digest that is biunique for different (self-extracting) executable files.

c) providing the CIDAA-capable software and contents on a web site for the download by the end user. The web site can be operated by the provider himself, by the network operator or by third parties (e.g., an internet service provider in the framework of the web hosting).

d) registering the newly prepared, CIDAA-capable software and contents at the network operator, so that he can assume the network-supported access control and charging for it. The access of the provider to the provider service web site of the network operator takes place as has already been described above relating to FIG. 5.

The access takes place via a web browser utilizing HTTPS; the corresponding service logic is realized on the server of the network operator via java servlets. As data per software product (e.g., an identification character (MD5 digest) of the software product, the charging model, prices, content rating, etc.) are respectively transmitted by the provider to the network operator for the acceptance in the product database.

The end user can download the software and contents in the framework of his normal activities when surfing on a web site (e.g., looking at pages, downloading software and contents) onto his terminal device after the provider has prepared the CIDAA-capable software and contents, has provided the CIDAA-capable software and contents on a web site and after the registration at the network operator site. The downloading by the end user takes place via standard HTTP by way of a standard web browser. In the case of software, the end user subsequently installs the application on his terminal device in a conventional manner.

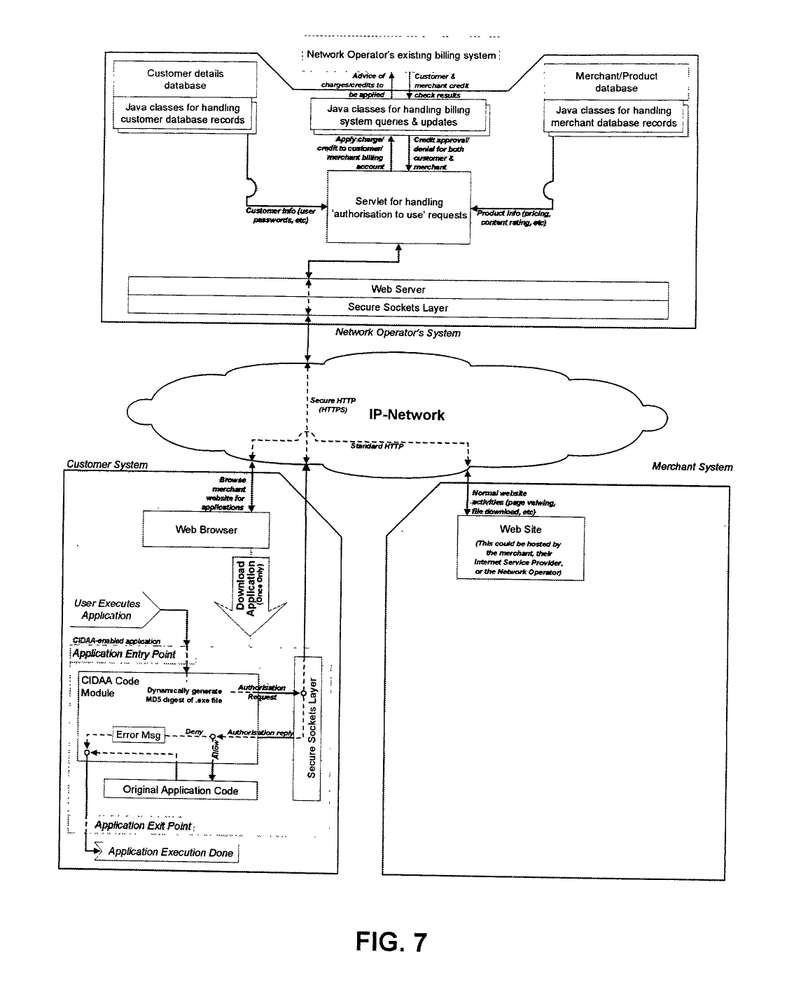

FIG. 7 shows a partial overview of the system with the essential elements for the usage of a CIDAA-capable software application and contents by the end user; the downloading and the potential installation of the software and contents by the end user on his terminal device has already been described in connection with FIG. 6.

As soon as the end user, on his terminal device, executes the executable file of the software application or the self-extracting executable file in the case of contents, the following steps occur:

a) the normal entry point of the (self-extracting) executable file gives the program control to the CIDAA code module, which has been built into the source code of the (self-extracting) executable file by way of the CIDAA development kit.

b) the CIDAA code module dynamically generates a MD5 digest of its own (self-extracting) executable file. The generation occurs in a dynamic manner in order to assure the authenticity and intactness of the software and contents. This is achieved in that the dynamically generated MD5 digest is compared to the MD5 digest that has been previously statically prepared by the provider by way of a digest generation tool (see the description of FIG. 6), where this statically prepared MD5 digest has been deposited on the server of the network operator.

c) the CIDAA code module sends an “authorization to use” request to the web server of the network operator via HTTPS. Parameters of the request are the dynamically generated MD5 digest and the user identification character and password dynamically inquired from the end user before the transmission of the request (e.g., by way of a pop-up-window).

d) a servlet with corresponding service logic accepts and processes the “authorization to use” request on the web server of the network operator. The necessary accesses to databases and charging system are realized by java classes.

The individual processing steps are:

d.1) Reading out the end user data (e.g., user identification character, password, content, restrictions, etc.) from the customer details database and, as far as possible, comparing these parameters with their corresponding parameters in the “authorization to use” request. This involves aborting and responding negatively with respect to the “authorization to use” request back to the terminal device of the end user when the user identification or password differ.

d.2) Reading out the data of the software product (e.g., the MD5 digest statically generated by the provider, the charging model, prices, content rating, etc.) from the “merchant/product database” and their comparison with the corresponding parameters from the “authorization to use” request, as well as with the data of the end user previously read out from the customer details database. For purposes of assuring authenticity and intactness of the software and contents, a comparison is performed, particularly between the static MD5 digest that is deposited in the software product data bank and the MD5 digest that is dynamically generated in the device of the end user for a call of the software and contents. This involves aborting and responding negatively with respect to the “authorization to use” request back to the terminal device of the end user when the MD5 digest, charging model or content rating differ.

d.3) Depending on the valid charging model, a further step is initiating a corresponding transaction for the credit entry/debit entry onto the account of the end user and/or of the provider in the charging system of the network operator.

This involves aborting and responding negatively to the “authorization to use” request back to the terminal device of the end user when errors occur in this step.

d.4) If no errors have occurred up to this point in this run of the service logic, a positive answer to the “authorization to use” request is sent back via HTTPS to the terminal device of the end user

e) The CIDAA module receives the response to the “authorization to use” request via HTTPS from the web server of the network operator

If the response is positive, the module branches to the original program run of the (self-extracting) executable file; this makes it possible for the end user to be authorized to use the software or to unpack the contents when the access control and charging by the central instance of the network operator was successful

If the response is negative, the module branches to a routine that outputs a corresponding error message for the end user; the unauthorized usage of the software or the unpacking of the contents by the end user is thus inhibited when the access control and charging by the central instance of the network operator failed.

f) Leaving and finishing the (self-extracting) executable file via the normal exit point.

The above-described method and related systems are illustrative of the principles of the present invention. Numerous modifications and adaptions thereof will be readily apparent to those skilled in this art without departing from the spirit and scope of the present invention.

What is claimed is:

1. A method for using software products that are offered via a network, comprising the steps of:
inquiring about a software product from an offer server by a user via a terminal device;
downloading said software product from said offer server via said network onto said terminal device in response to said inquiry of said user;
activating a software component of said software product;
starting a communication by way of said software component with a usage processing server regarding a usage of said software product in response to a call of said software product in said terminal device of said user;
providing, by said software component in a framework of said communication, data to said usage processing server; and
checking said data, by said usage processing server, and then making a determination selected from the group consisting of: whether usage of said software product is approved with respect to said inquiring user, and whether charging operations are carried out on user accounts and provider of software product accounts.

2. A method according to claim 1, further comprising the step of operating said usage processing server by a network provider.

3. A method according to claim 1, further comprising the step of operating said offer server by a network provider.

4. A method according to claim 1, further comprising the step of using a web server for a server selected from the group consisting of said offer server and said usage processing server.

5. A usage processing server comprising:
a usage processing module for processing a software product downloaded from a network;
wherein said usage processing server is contacted by said software product after said software product has been downloaded into a terminal device of a user and has been activated; and
wherein usage processing data required to perform usage processing are delivered to said usage processing server.

6. A usage processing server according to claim 5, further comprising:
a data store in which a software product identification of said software product and type of usage processing data that prescribe a type of usage processing of said software product are stored by said usage processing module, and
wherein said usage processing module registers said software product.

7. A usage processing server according to claims 5, wherein:
said usage processing data required comprises a software product identification of said software product and a user identification.

8. A usage processing server according to claim 5, wherein:
said usage processing comprises performing an access control.

9. A usage processing server according to claim 5, wherein:
said usage processing comprises performing a usage charging of said software product on user accounts and provider accounts.

10. A usage processing server according to claim 5, wherein:
said usage processing module keeps statistics about usage contacts that have taken place and about results of a processing of said usage contacts.

11. A software product, comprising:
a software component that is activated when called by said software product and that subsequently starts communicating with a usage process server and delivers usage processing data required for performing usage processing to said usage processing server in the framework of said communication;
wherein said software product can be downloaded into a terminal device by a user via a network in response to an inquiry from said user.

12. A software product according to claim 11, wherein said usage processing data comprises:
software product provider data; and
software product identification; and
wherein said usage processing data is dynamically determined user data.

13. A software product according to claim 12, wherein said software component interacts with said user to produce said dynamically determined user data.

14. A method for the generation of a software product that is offered via a network, comprising the steps of:
installing a software component in source code of said software product of a software manufacturer by using a software development kit provided by a usage processing provider;
activating said software component when called by said software product;
starting a communication by said software component with a usage processing server after said step of activating said software component;
sending, by said software component, usage processing data that are required for performing usage processing to said usage processing server in the framework of said communication.
